(19) United States
(12) Patent Application Publication
(10) Pub. No.: US 2012/0189990 A1
(43) Pub. Date: Jul. 26, 2012

(54) Method and System for Training Number Sense

(76) Inventors: Daphne Bavelier, Rochester, NY (US); C. Shawn Green, Madison, WI (US); Justin Halberda, Baltimore, MD (US); Alexandre Pouget, Rochester, NY (US)

(21) Appl. No.: 13/301,392

(22) Filed: Nov. 21, 2011

Related U.S. Application Data
(60) Provisional application No. 61/415,559, filed on Nov. 19, 2010.

(51) Int. Cl. G09B 19/02

(52) U.S. Cl. 434/188

(57) ABSTRACT

A system and method are disclosed for training number sense of a person by providing content which challenges the approximate number system in the context of an interactive video game. The training of non-verbal number sense is fostered through brain plasticity and learning associated with dynamic interactive video game environments. The present invention may provide tasks to a player through an interactive video game. Actions are received from the player, and a number sense acuity value is measured based on those actions. Feedback is provided to the player based on the number sense acuity value.

### CROSS-REFERENCE TO RELATED APPLICATION

This application claims the benefit of priority to U.S. provisional patent application Ser. No. 61/415,559, filed on Nov. 19, 2010, now pending. The disclosure of the above priority document is incorporated herein by reference.

This invention was made with government support under grant EY016880 awarded by the National Institute of Health and grant N00014-07-1-0937 awarded by the Office of Naval Research. The government has certain rights in the invention.

### FIELD OF THE INVENTION

The present invention relates to the field of training number sense in a person.

### BACKGROUND OF THE INVENTION

All individuals intuitively represent numbers with a series of imprecise mental magnitudes whose degree of imprecision grows in direct proportion to the target number. When asked to identify the larger of two quantities, subjects are faster and more accurate when the numerical distance between the two quantities increases. For a fixed distance between quantities, they are slower and more error-prone as the quantities grow. Combined, these distance and size (quantity) effects yield a strong ratio-dependence of numerical estimates. The ability of a subject to discriminate between two approximate quantities depends not on their absolute values of the quantities, but on the ratio between the quantities.

This ratio-dependence has been observed in tasks requiring adults to estimate numbers of stimuli, produce target numbers of actions, judge the more numerous of two stimulus arrays, and estimate the results of non-symbolic arithmetic events (activities relevant to assessment and intervention). This ratio dependence is the hallmark of intuitive “number sense.” It derives from the noisy approximate number representations of our Approximate Number System, the cognitive system supporting our basic number intuitions.

Number sense is a universal skill. Research shows that a basic, non-verbal number sense is present in educated Western adults, in members of cultures that lack formal number systems, in pre-verbal human infants, and in other animal species. Thus, in contrast to the notion that all numerical abilities are acquired through explicit instruction, number sense appears to be fundamental to human (and some animal) cognition. However, there are individual differences in the acuity of the number sense. When judging the more numerous of two arrays, some young adults can reliably distinguish numbers of items that are very close, such as 10:11, while others have difficulty with ratios as easy as 3:4.

The role of the brain is to take in sensory information, combine it with past experience and future goals, and then determine the right action to take at every moment. However, because there is uncertainty throughout (e.g., “Is the animal moving in the trees predator or prey?” “Is this the same location in the stream I crossed before?” “Will the branch hold my weight?”), the best the brain can do is compute its best estimates of the probability of the various objects and possible outcomes as well as its certainty in those estimates. Without both the estimated probability and the certainty of the estimate, it is not possible to know the right thing to do (e.g., the right thing to do might be very different if you are extremely confident that there's a 95% chance that the animal in the trees is prey and 5% chance that it is a predator, than if you believe the same probabilities, but are less sure of your estimates).

Computations in a probabilistic framework involve statistical inferences. For instance, while we might think of addition as an operation that returns the sum of two numbers, the same operation involves a different type of computation, known as Bayesian inference, when working with probability distributions. In Bayesian inference, the goal is to perform an inference which returns the probability distribution over the sum given the probability distributions over the two numbers to be summed. In other words, a Bayesian inference would not only return the mean of the sum, but also the confidence in the result.

The concept of prior knowledge, or prior distributions, provides a rational way to take into account any prior knowledge we may have. For example, in the real world, most objects tend to be still or to move slowly. This suggests that human perception should be the result of combining information with a prior belief that objects tend to move slowly.

Many tasks, including some that we consider as symbolic (e.g., adding two numbers), can be understood as resulting from a statistical inference process. Thus, finding a training regimen that enhances statistical inference in general is invaluable, as it aids not only learning the trained material, but also generalization to new material and new contexts.

Each person has a ratio at which it becomes difficult to accurately determine the more numerous of two arrays. This threshold ratio is typically different for each person, stable for each person, and specified by the underlying noise in each person's approximate number representations. This ratio can be reported as a Weber fraction (w) that represents the smallest change to a stimulus that can be consistently detected. The Weber fraction not only describes the closest numerical ratio that can be reliably discriminated, but also the amount of error in the underlying approximate number representations for each person. A person's Weber fraction can be used as an index of the acuity of their number sense.

Approximate Number Sense (ANS) acuity, also referred to herein as number sense acuity, has been found to improve throughout the school-age years, from age 3-years old through adulthood, as shown in FIG. 1. Over 50,000 individuals from 3-years to 85+ years of age have been tested using a same simple task of determining which array (yellow or blue) has more dots in a common ANS assessment.

Individual differences in number sense acuity in 7th grade have been shown to retrospectively predict individual differences in school math achievement. Throughout grade school, math achievement was assessed using the Test of Early Mathematical Ability—Second Edition (TEMA-2) and/or the Woodcock-Johnson Revised Calculation Subtest (WJ-Rcalc). Correlations were determined between students' number sense acuity and their standardized test performance for every year that testing had been performed. It was found that students' number sense acuity correlated with math achievement in every year tested (Kindergarten through 6th Grade) for both TEMA-2 and WJ-Rcalc, as shown in FIG. 2. This means that number sense acuity in 9th Grade retrospectively predicted math achievement from as early as Kindergarten—a nine-year time span.

These correlations between number sense acuity and school math achievement remain significant when controlling for general IQ, task performance factors, and other standardized measures—including other cognitive abilities that previously have been discussed in the literature as predictors of school math achievement (e.g., executive functions, working memory, visual-spatial abilities, and verbal abilities). This means that success on tests of addition, subtraction, multiplication, division, decimals, and fractions throughout the school years can be predicted by a student's number sense acuity in young adulthood, as measured by the simple task of determining which of two quickly flashed arrays has more dots, even when extensive controls are in place for other cognitive and performance factors.

Number sense acuity appears to be a powerful cognitive predictor of math achievement; stronger than other abilities that have been previously correlated with math achievement.

ANS acuity predicts how good a student will be in scholastic mathematics. In a sample of 18 children, each child's ANS acuity at age 3-years old predicted these same children's scores on the TEMA test of basic math skills and their performance on symbolic addition and subtraction tasks measured when the children entered school and again at age 7-years. This demonstrates the relevance of ANS acuity for beginning mathematics and the potential importance of intervention at ages as young as 3-years of age.

ANS acuity is reflected by the engagement of brain areas (parietal cortex/intraparietal sulcus (“IPS”)) during number sense tasks. Data from brain imaging and neurophysiology point to an area of the parietal cortex as the neural substrate for the ANS beyond what is required for general visual stimulus processing, working memory, and response planning Moreover, neural activity in the IPS is modulated by the same ratio-dependence that modulates behavioral performance. When participants compare dot arrays to a standard array, the percent signal change in the IPS fluctuates as a function of the ratio between the numerosities.

Relevant to school math achievement and intervention, students whose school math performance is in the lowest 10%, identifying them as having a math learning disability, show reduced activation in the ANS area of the brain and have reduced cell density in this area.

Competence in non-verbal number sense acuity (the ability to judge the approximate number of items in visual or auditory arrays without verbally counting) is known to lead to achievement in symbolic math. However, previous stimulus sets and procedures to measure number sense are incomplete and only partially effective for limited populations.

One such study proposed an activity called “The Number Race.” The activity involved a single task (i.e., choose the greater number) with variability from trial-to-trial in the presentation format of the two number choices. The formats involved include discrimination of dot arrays, single digit Arabic numbers, and symbolic addition and subtraction with Arabic digits. The math problems are presented as a two-alternative, forced choice where the student must decide which array results in a larger number and choose that array before the opponent in order to maximize points. Such a restricted range of decision-making is unlikely to result in the type of general improvement in number representation and math reasoning that is required in school mathematics. The Number Race tracks player performance in reaction time, accuracy, and problem difficulty and dynamically adjusts to the player as a function of their performance. Dynamic adjustment to player performance is also used in “Panamath,” to assess the precision of a player's number sense. While the reaction time component is beneficial (the player needs to beat an opponent and make a decision before they do so in order to maximize points), the math problems are presented in a static environment and are very stereotyped (coming only in three basic possibilities). This kind of activity does not require rapid adjustment, on the part of the player, to different sources of evidence in an uncertain environment nor does it require dynamic decision making Other studies and their results are outlined in FIG. 5.

Others have used a board game played with physical pieces on a playing board. This intervention was motivated from the idea that building a linear representation of how numbers map onto space would help children in understanding what are basically linear transformations on the numbers such as addition and subtraction (e.g., addition means getting bigger and moving to the right on the number line, subtraction means getting smaller, and how much bigger and how much smaller depends on the numbers involved). This number board game does not require the rapid decision making that is critical to robust improvements in number sense.

The Number Race and the number board game lead to marginal improvements in symbolic number comparison and some improvements on other tasks involving numbers that are not directly the tasks involved in the games. However, while both of these games may be valuable for the lowest achieving individuals who likely could benefit from any intervention, the use of these particular interventions may not result in improvement for individuals at any skill level, nor improvement that generalizes broadly across math tasks. The critical limitation of both of these existing interventions is that neither of them is “interactive”—engaging the rapid switching of attention and the dynamic adjustment to sensory evidence in the service of numerical decision making, which is important for robust improvement in ANS acuity and related improvement in school mathematics.

The typical finding in the prior art learning literature shows learning is nearly always specific to the trained task and stimuli. For instance, training on the video game Tetris® results in the development of expertise at mentally rotating Tetris®-like shapes, but trained individuals do not show the same improvements in the ability to mentally rotate shapes that are not part of the Tetris® register.

Prior studies have investigated possible interventions on the number sense and the impact of those interventions. These studies have focused on children between the ages of four and seven years of age. None of the studies to date have looked at how intervention on the number sense of a person can improve school math performance across the life span of that person. Also, the majority of the studies involve rather small sample sizes and have focused on improvements for children coming from low socio-economic status (SES) environments or children suffering with math learning deficit (MLD). There remains a need for intervention for all skill levels from high-achieving children through children with math disabilities.

### SUMMARY OF THE INVENTION

The invention may be embodied as a method or system for training number sense of a player. One embodiment in keeping with the present invention involves a method of providing an interactive video game, presenting a task to a player using the interactive video game, receiving action information from the player in response to the presented task, measuring a number sense acuity value of the player, and providing feedback to the player. The video game is interactive in at least the sense that it is fast-paced, requires rapid attention switching on the part of the player, and/or dynamic adjustment by the player to sensory evidence provided by the game.

The invention may also be embodied as a system comprising a display, and a video game system. The video game system comprises a processor and an input controller. The input controller allows the player to interact with the video game system. The processor is programmed to present a task to the player, receive action information from the input controller, measure a number sense acuity value of the player, and provide feedback to the player based on the measured number sense acuity value.

The invention can be embodied in such a way that recognizes the relationship between activation, ANS acuity, and school math performance for normally achieving children as well as children coming from low SES environments or children suffering with MLD. The present invention provides a game to teach number sense acuity informed by the discovery that ANS works according to the same principles of rapid statistical inference that are involved in the task switching, decision making, and speed of processing dimensions present in action video games. The methods and systems for training number sense of the present invention, allow for a fast and efficient determination of the number sense in an individual (a player). The disclosed methods and systems can be used to assess a player's number sense at different stages of game play.

Fast-paced, perceptuo-motor training regimens, such as first-person action video games, lead to a wide array of behavioral improvements. Training with such games results in improvements in basic visual skills, selective attention in both space and time, sustained attention over time, and capacity to track multiple objects. Cognitive skills such as subitizing and verbal counting, mental rotation, task switching, decision-making, and the general speed of processing are also improved.

The broad transfer engendered by action video game experience can be explained by a single common mechanism—the ability to perform statistical inference, a process that is constantly used by the brain as information is passed from one neural network to another in the service of action. All of the tasks on which action game players have been shown to excel can be understood in this framework of statistical inference. It follows naturally from better statistical inference that gamers exhibit higher performance on so many different skills.

An exemplary embodiment of the present invention is a game for children aged 4-9, which is the age range in which the largest improvement in the approximate number sense occurs. Another embodiment is a game for general family use for ages from 6- to 96-years old, as the approximate number sense acuity is seen to improve until about 30 years of age and then decline in older age. Such a general family game would also be of value to older people to slow cognitive decline in this fundamental approximate number sense capability.

### BRIEF DESCRIPTION OF THE DRAWINGS

For a fuller understanding of the nature and objects of the invention, reference should be made to the following detailed description taken in conjunction with the accompanying drawings, in which:

FIG. 1 is a graph showing Weber fraction (w) as a function of age;

FIG. 2 is a table showing longitudinal correlations of number sense acuity with math achievement;

FIG. 3A depicts two sets of stimuli, each set having a different color;

FIG. 3B is a graph showing a relationship of correct responses to the ratio of the sizes of sets of stimuli;

FIG. 3C is a histogram showing a distribution of Weber fraction values for a number of test subjects;

FIG. 4A is a graph showing Weber fraction values related to WJ-Rcalc measures;

FIG. 4B is a graph showing Weber fraction values related to TEMA-2 measures;

FIG. 5 is a table of prior art testing and measurement regimes;

FIG. 6 illustrates an embodiment of a method according to an embodiment of the present invention;

FIG. 7A illustrates a method of presenting a task to a person according to an embodiment of the present invention;

FIG. 7B illustrates a method of presenting a task to a person according to another embodiment of the present invention;

FIG. 7C illustrates a method of presenting a task to a person according to another embodiment of the present invention;

FIG. 8A illustrates a method of presenting a task to a person according to another embodiment of the present invention;

FIG. 8B illustrates a method of presenting a task to a person according to another embodiment of the present invention;

FIG. 8C illustrates a method of presenting a task to a person according to another embodiment of the present invention;

FIG. 8D illustrates a method of presenting a task to a person according to another embodiment of the present invention;

FIG. 9 is a flowchart of a method according to another embodiment of the present invention; and

FIG. 10 shows a system according to an embodiment of the present invention.

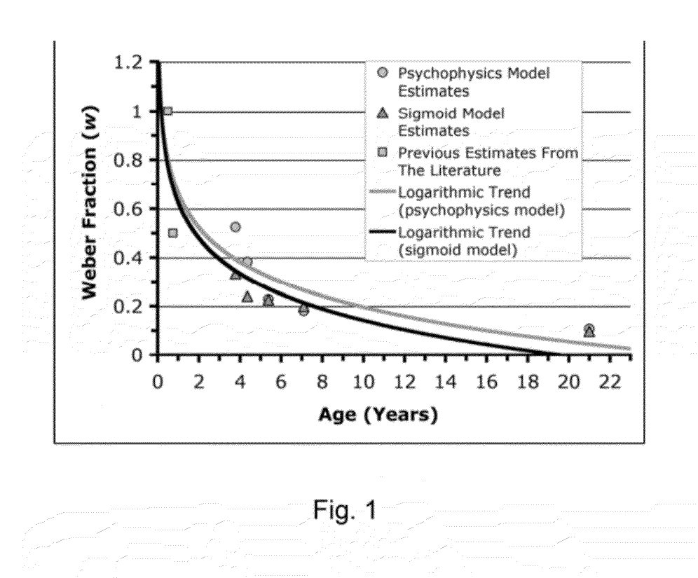

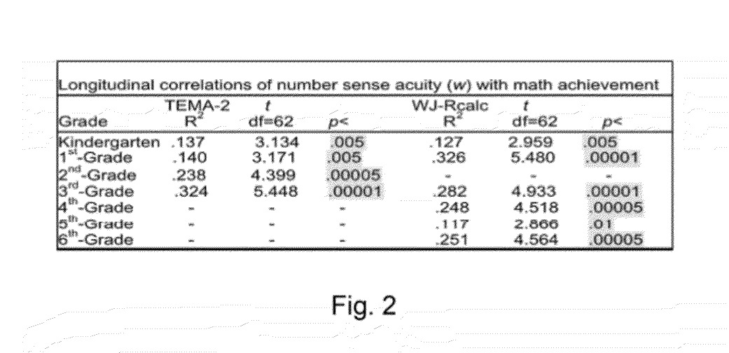

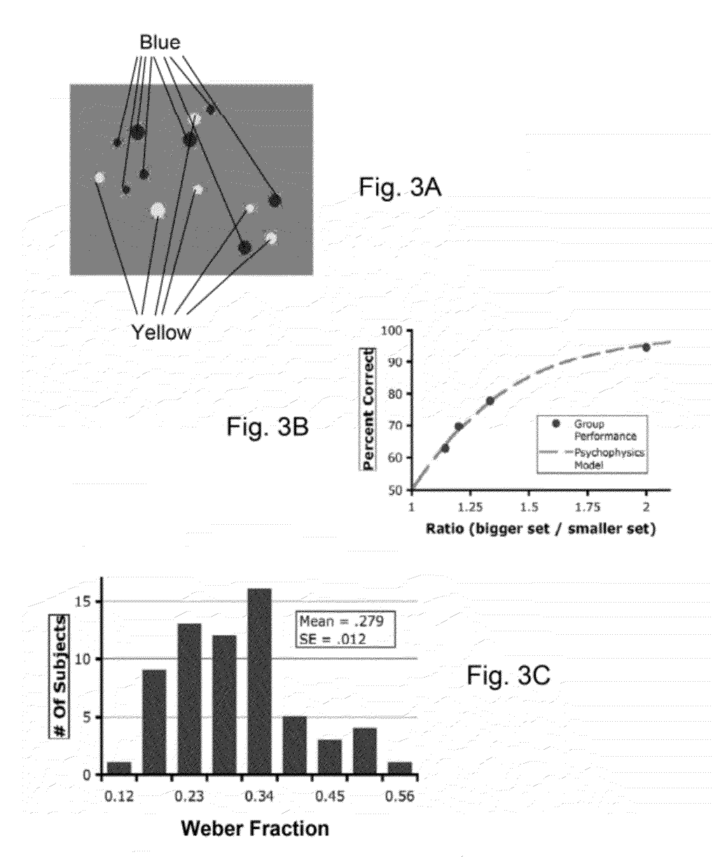

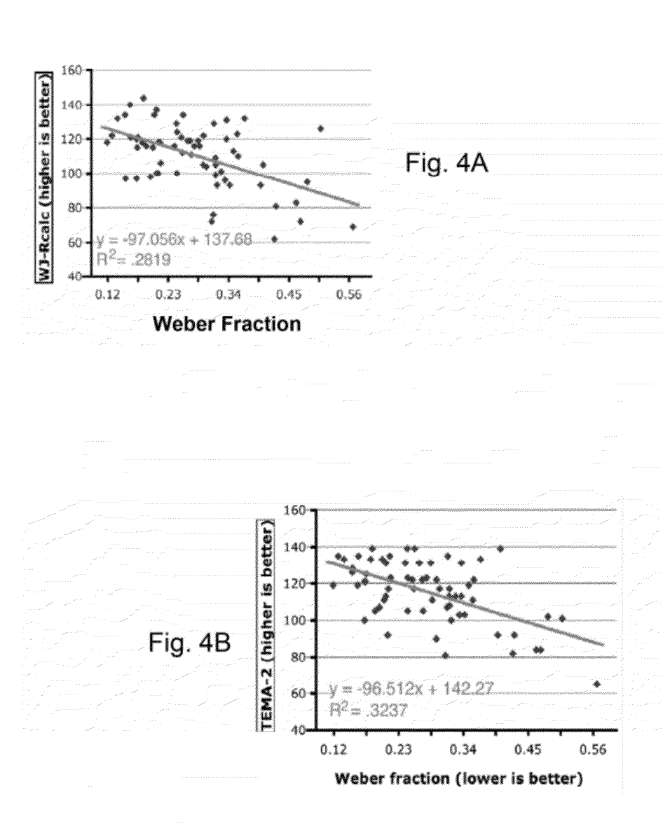

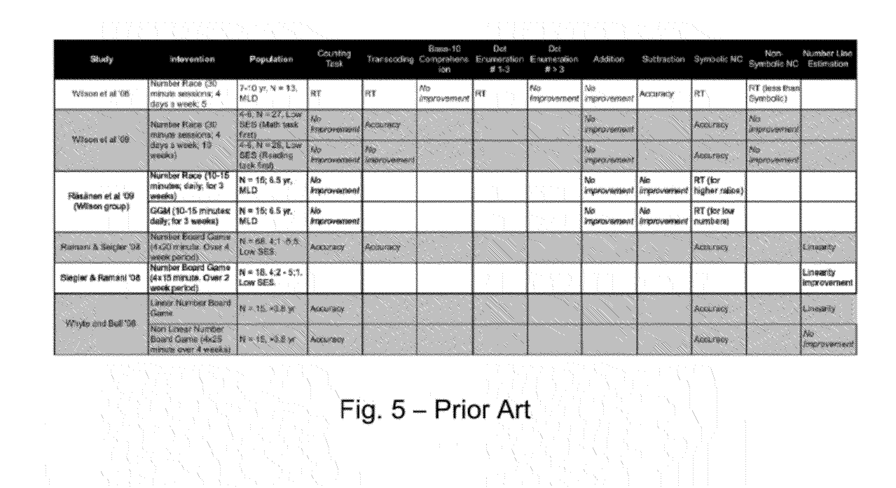

### FURTHER DESCRIPTION OF THE INVENTION

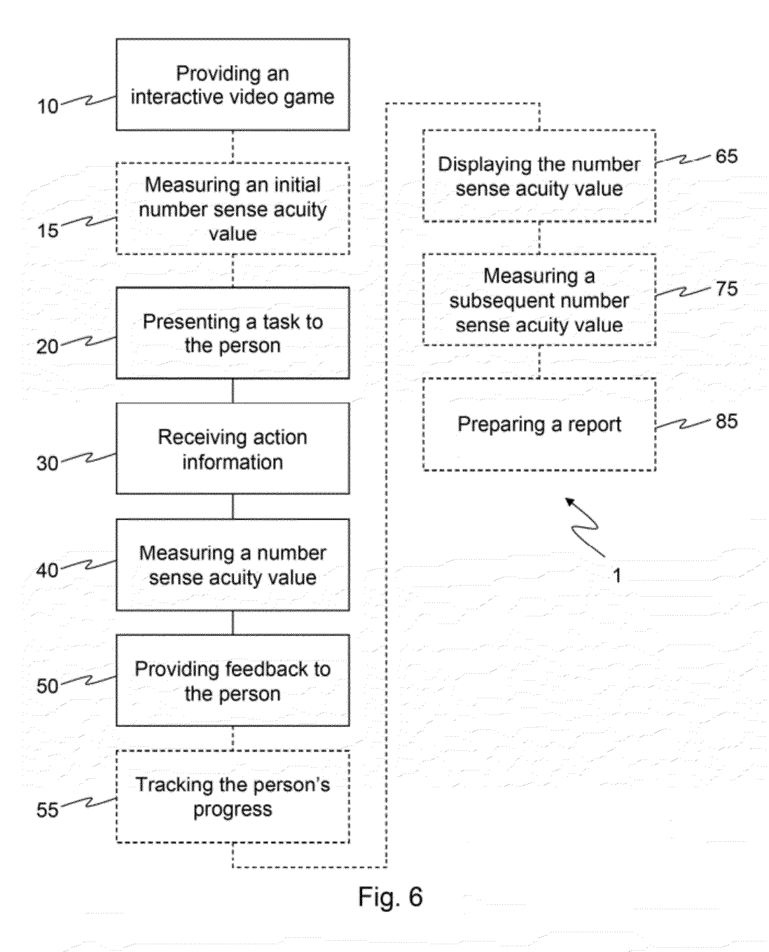

FIG. 6 depicts a method 1 of training a player to improve their number sense acuity according to an embodiment of the present invention. The player may be of any age.

While examples in this disclosure may refer to children, it should be understood that the disclosure is applicable to any age. The method 1 comprises the step of providing 10 an interactive video game. The interactive video game may be embodied as software for execution by a processor, as a processor dedicated to executing interactive video games, or as any combinations of software and hardware. The interactive video game may have one or many environments that can be experienced by the player through an avatar. For example, the video game may be a so-called “first-person action” (FPA) video game, where the video game is played form the point-of-view of the avatar. The player can control and manipulate the avatar. The player may command the avatar to act, for example, to move, observe, or perform a variety of other actions. Some of these other actions may be directed at the interactive video game environment or the player's avatar. The interactive video game may react to the avatar's actions. In some embodiments, the interactive video game establishes a story or plot to provide a fictional purpose to advance and motivate the avatar. The interactive video game may be provided 10 through audio, visual, touch, and/or any other presentation mode(s).

The method 1 of the present invention comprises presenting 20 a task to the player, the task being presented 20 using the interactive video game. The task may be presented 20 implicitly or explicitly. For example, an explicit task might be presented 20 by a narrator character in the interactive video game through an introduction to a game level. A checklist may be presented 20 to the player, and the player may complete tasks on the checklist in any order. In another example, an implicit task may be presented 20 through elements of the interactive video game environment. In one embodiment, the flood level of the environment may be constantly rising and the task presented 20 to the player is to escape danger, despite never being explicitly informed to do so. Implicit tasks may be presented 20 as subsets of explicit tasks. For example, a player may be given a broad, explicit objective of driving in a vehicle from one point to a destination. However, the task of refueling and repairing the vehicle may be presented 20 to the player implicitly as a means to complete the explicit objective.

An objective of the interactive video game of the method 1 is to integrate one or more numerically significant tasks into dynamic game-play. In some embodiments of the present invention, the player enters a sub-game within the video game to engage in number discrimination. In other embodiments, the player does not enter a sub-game within the main game in order to engage in number discrimination, but rather number discrimination is an integral part of the decision making process inside of the game-play itself.

Another objective is to create uncertainty and require dynamic adjustment on the part of the player in order to gather the evidence required to make these decisions. In one such embodiment of the game, each of the six basic tasks is presented in a noisy and probabilistic environment where the player must rapidly make number-relevant decisions by relying on a variety of sources of noisy evidence. For example, the player must decide how many game characters are approaching, but those characters are presented as approaching through fog and/or tree cover such that it is difficult to estimate their number. In this example, the fog and/or tree cover may be considered as “noise.”

The task may be presented 20 through more than one modality. For example, the modalities may be vision and/or audition. In one embodiment, the modalities through which tasks are presented 20 vary throughout the interactive video game. In another embodiment, more than one task may be simultaneously presented 20 to the player, wherein each task has a different temporal scale.

Which sensory modality and which dimension within a sensory modality provides the best evidence for any particular decision may be dynamic and varied throughout the game. For example, where a task calls for estimating the number of game characters, the estimation may best be accomplished by the player focusing on bright colors among muted tree cover. In another scene it is more useful to focus on the motion of the characters as opposed to the non-motion of static cover. In another example, it may be useful for the player to focus on the rectilinearity of vehicles among the curvilinearity of the ground cover, while in another it is better to focus on the sound of the approaching character voices from around a curve when no vision is possible or the cover is too thick. In yet another situation, when visual access is limited within the video game, the player may need to focus on a distinct sound for each of the approaching vehicles in order to estimate their number and type, etc.

Having such numerically relevant tasks integrated within the interactive video game of the present invention, and presenting numerical decisions in situations that require rapid adjustment on the part of the player to determine what is the best source of evidence, will lead to improvement in the precision of the number sense of the player. This improvement is generalized across varied situations including those not disclosed herein.

Embodiments of the present invention bundle many number tasks within game-play, fine-tune the variability of the numbers involved, and vary the information that the player must use to determine the numbers. An embodiment of the present invention may engage the ANS of the player in tasks that: (1) estimate the number of stimuli over time and/or space, (2) produce a target number of actions (e.g., button presses), (3) judge the more numerous of two stimulus arrays, (4) estimate the results of both symbolic and non-symbolic arithmetic events (e.g., adding one set of dots to another set of dots, or adding two Arabic digits), (5) act upon events in the game to organize them according to their numerosity (descending or ascending order), and/or (6) reorganize events along different dimensions as the game proceeds. The video game may present one, some, or all of these tasks throughout the game. All six of these tasks can be presented in the same or different modality including vision, audition, and/or touch (e.g., a number of beeps in a string of beeps). All six of these tasks can be integrated into natural game-play as dynamic and engaging elements of the game.

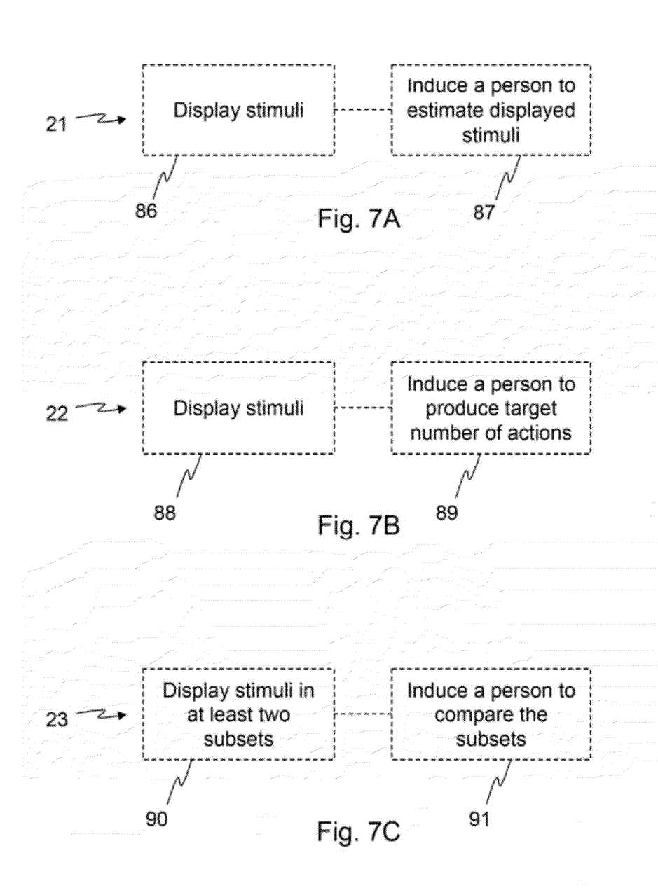

As illustrated in FIG. 7A, the step of presenting 21 a task may further comprise the sub-steps of displaying 86 a plurality of stimuli on a display, and inducing 87 the player to estimate the number of displayed stimuli. The player may be induced 87 to estimate the displayed stimuli over a period of time and/or within a space.

As illustrated in FIG. 7B, the step of presenting 22 a task may further comprise the sub-steps of displaying 88 a plurality of stimuli on a display, and inducing 89 the player to produce a target number of actions.

As illustrated in FIG. 7C, the step of presenting 23 a task may further comprise the sub-steps of displaying 90 a plurality of stimuli on a display, the plurality of stimuli arranged in at least two stimuli subsets, and inducing 91 the player to compare the number of stimuli in the at least two stimuli subsets.

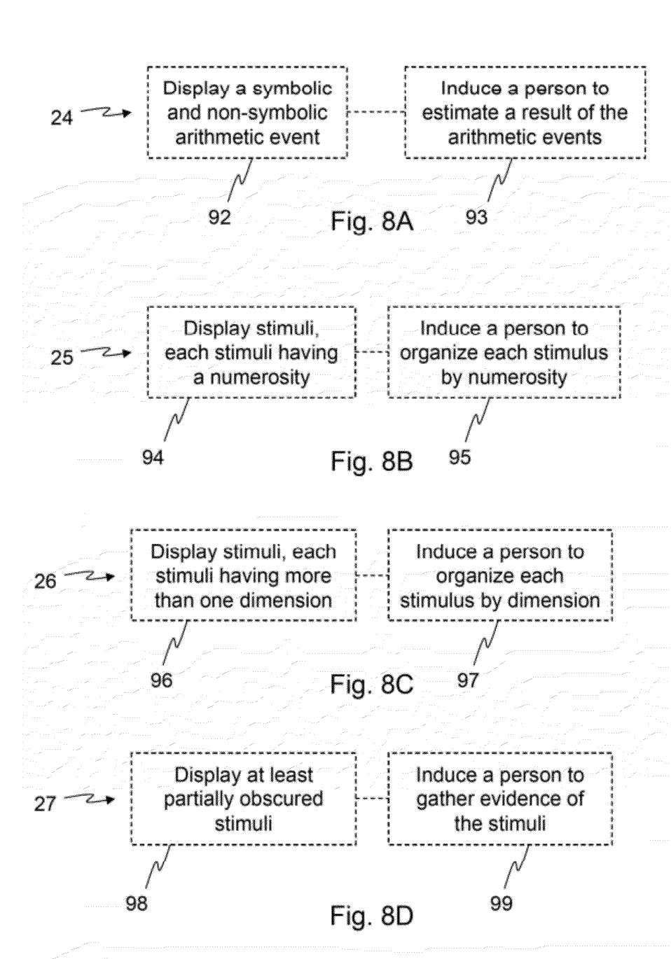

As illustrated in FIG. 8A, the step of presenting 24 a task may further comprise the sub-steps of displaying 92 a symbolic arithmetic event and a non-symbolic arithmetic event on a display, and inducing 93 the player to estimate a result of the symbolic arithmetic event and the non-symbolic arithmetic event.

As illustrated in FIG. 8B, the step of presenting 25 a task may further comprise the sub-steps of displaying 94 a plurality of stimuli on a display, each stimuli having a numerosity; and inducing 95 the player to organize each stimulus according to numerosity.

As illustrated in FIG. 8C, the step of presenting 26 a task may further comprise the sub-steps of displaying 96 a plurality of stimuli on a display, each stimuli having more than one dimension, and inducing 97 the player to organize each stimulus according to the dimensions of the stimulus.

As illustrated in FIG. 8D, the step of presenting 27 a task may further comprise the sub-steps of displaying 98 a plurality of stimuli on a display, the stimuli at least partially obscured, and inducing 99 the player to gather evidence of the stimuli through altering the player's view in the interactive video game.

Method 1 further comprises receiving 30 action information from the player in response to the presented task. In some embodiments, action information is received 30 through the use of an input controller. The input controller may include, but is not limited to, a mouse, keyboard, gamepad, joystick, or sensor. The action information may manipulate the avatar or the video game environment. There need not be a 1:1 relationship between action information and changes in the interactive video game. Action information may alter one or more conditions in the interactive video game based on the context of the received 30 action information.

Method 1 further comprises measuring 40 a number sense acuity value of the player based on the received action information. The measuring 40 may take place in a manner transparent to the player. For example, number sense acuity may be measured 40 throughout the interactive video game without the player being aware that the number sense is being measured 40.

Method 1 further comprises providing 50 feedback to the player, the feedback being provided 50 using the interactive video game based on the number sense acuity value. For example, the provided 50 feedback may be positive or negative depending on the number sense acuity value. The difficulty of the interactive video may decrease or increase accordingly. The player may be provided 50 with bonuses or penalties that affect the interactive video game environment or the avatar.

Embodiments of the present invention may use interactive video games having the kinds of active switching of attention that an action video game requires in a dynamic and quickly moving environment, but the virtual environment need not involve violence. The examples herein simply to illustrate the types of actions required, and it will be apparent that such actions can be translated to other environments. For example, an interactive video game of the present invention could require the player to estimate a number of friendly animals such that the player could correctly give a flower to each of the animals.

In an example of a task inducing the player to estimate a number of stimuli, the player may be given a choice among possible tools in their toolbox. For example, one such tool may be the most accurate; another tool may be fast for small numbers of operations and is slightly more costly than the first (e.g., in terms of resources, etc.); and a third tool may be costly, may be fairly accurate and may be extremely fast.

As the player approaches a task requiring the use of a tool, the player must assess the appropriate tool to use depending on the number of game characters present. Examples of the criteria used to make such a tool selection are: maximizing accuracy while minimizing cost, or minimizing required time and cost, etc. To increase number-relevant computations, for example, use of the tools may also require the player to determine and load the appropriate amount of consumable items. In this way, the player is placed a position to make a speed-accuracy tradeoff. The limitations on the availability of a required consumable in the environment places a constraint in that the player must try to minimize the amount of that consumable used. In another example, there may be a cost for overestimating the amount of consumable required, such as where the weight of carrying excess consumable items causes a slower maximum speed of the player's avatar.

In another example of an interactive video game, the player may need to perform kind acts for as many friends as possible, and the player has a choice among different types tools (e.g., magic wands) for performing such acts of kindness. The selection of available magic wands may be designed to cause a rapid speed-accuracy tradeoff decision to be made by the player. The play environment may be selected to cause the player to make the speed-accuracy decision based on number-relevant information (e.g., the number of friends requiring acts of kindness).

In another embodiment of the present invention, the player may be placed in a situation where the player must both rapidly estimate the number of game characters, and rapidly estimate the amount of operations required to respond to the number of characters. The payoff structure can be formed such that there is a cost paid for inaccurate estimation. The cost for inaccurate estimation can be adjusted dynamically in response to the player's skill level or dynamically across levels. For example, an early level may involve lower costs for inaccurate estimations and a wider range of acceptable estimations, where at a higher skill level there is a high cost for inaccurate estimations.

Another example of a task is inducing the player to produce a target number of actions. In an embodiment of the present invention, inducing a target number of actions of the player is integrated into the game.

Another context could be adjusting the rate of produced actions. For example, the rate is equal to number of actions divided by time, and correctly estimating rate has been shown to depend on correctly estimating the number of events required, divided by correctly estimating the amount of time over which those events should span. For example, some actions in the game can require matching the player's avatar's movements across a number of steps to the rate of oncoming landing positions. For example, oncoming logs in a stream are presented to a player and the player must hop from one log to the next thereby requiring the player to press the jump button at exactly the same rate that the logs are falling so as to successfully jump from one to the next. Because many aspects of the game-play, from movement to actions, can require a specific number or rate of actions from the player, produced number of actions can be integrated in many places within the game.

In another embodiment of the present invention, a player may be induced to judge the more numerous among several stimulus arrays. Discrimination on the part of the player may take place at many levels within the game in parallel. This allows ordinal number judgment to be integrated into the video game. One very natural type of decision in the game that could be made to involve discriminations across a number of stimuli in an array is a decision about avatar movement in the environment. For example, deciding which of two paths to take within a cave environment might depend on the number of boulders on those two paths, where maneuverability is better on the path with fewer boulders. Ordinal number judgment may further include additions and subtractions in the environment. For example, while boulders might incur a particular cost in maneuverability, vines might offset those costs to some extent by allowing the player's avatar to swing over the boulders thereby requiring the player to do an analysis of the concentration of boulders to the concentration and spacing of vines in order to determine which of two paths leads to the better outcome in terms of maneuverability. A path with many boulders but equally many well-spaced vines could turn into a path where only rapid and accurate swinging occurred and the boulders were a non-factor.

In another embodiment of the present invention, a player may be induced to estimate the results of non-symbolic arithmetic events. While additions and subtractions of number symbols (e.g., Arabic numerals) may appear to a child as an explicit number task (i.e., an educational game), the very same actions and computations can be integrated into the game using non-symbolic number representations such that the child feels they are natural and not artificial. A further advantage is that this can be effective at avoiding math anxiety. Children would be engaging in practicing mathematics without the game triggering the child's anxiety about mathematics.

An aspect of a video game that requires estimating the results of non-symbolic arithmetic events may be estimating the total number of game characters in a group where the entire group is not accessible at any one time. For example, viewing a group of game characters where some characters and/or portions of the characters in the group are hidden behind occluders from multiple views. In such a case the player must collapse across the partial evidence allowed from multiple partial views. In one example, the player may run around the group to take some assessment of the numbers involved in order to plan an response and select the proper tool to perform the action with the least cost.

In another game context, a player may need to decide which of two skate parks to skate in order to maximize the points that are gained from various types of coins and rewards in the parks. In one embodiment, red coins are worth five points and blue coins worth two points, the player would need to assess the number of red coins independent of the number of blue coins and add the respective assessed values to determine which park had the better total payoff. The player would then choose that park with the highest total payoff in order to maximize gains.

Generally, the more static the decision, the less value it will have for improving number sense precision and the less generality it will have. The video game may place these numerical decisions (like non-symbolic addition) in as dynamic a context as possible with limited views and changing information structures. For example, coins may not be static and enduring in their positions, but moving and changing such that the player gathers evidence more continuously and integrates the evidence across multiple views. This technique provides a more dynamic process compared to a simple, one-off static estimation and/or one-off static addition in order to make a decision.

Another embodiment of the present invention may include integrating numerical estimation into the game by engaging the mapping between number and space. One forum for explicitly mapping number and space may be in the display(s) that track a player's progress through the game. For example, points can be displayed both visually (e.g., with digits), but can also (or alternatively) be displayed with lines and “maps.” For example, completion of a level could be displayed in a linear graph, and the player's progress within a level may be noted on the graph (e.g., the player's position specified by percent of available achievements made).

Multiple dimensions of interest may be simultaneously displayed such that prioritizing attention is required. For example, rather than a single graph marking out achievements, the graph may also have lines and marks for current weaponry achieved, current ammunitions levels achieved, resources gained of various types, defensive clothing obtained, intelligence, speed, agility and skill levels, etc. Having multiple dimensions of interest enhances the experience of each player and empowers dynamic shifting of attention on the part of the player. This is an effective way of training statistical inference. In one example, a player might choose to focus on speed and agility while another chooses to focus on the use of tools.

The video game may present statistics to players in a noisy and dynamic way that requires the player to actively engage with assessing the value on any one dimension as that value shifts dynamically—these may not be static displays. For example, statistics such as energy, efficiency, and/or speed can rapidly and continuously adjust during the video game on a moment-by-moment basis, not simply continuously as they grow slowly during the game. In one embodiment (a car-racing game), the display may allow the player to watch their car's efficiency continuously change, during shifting, braking, acceleration, etc.

Active continuous changes and dynamic adjustments require the player to change attention dynamically during the game. Strategically changing attention requires a type of statistical inference on the part of the player. For example, in one part of a video game level, monitoring efficiency may be important. The player could make their way across a desert where limited resources are available. However, the desert should be very short-lived so it is not a static portion of a level, but rather a dynamically changing environment. In another portion of the level, speed may be the most important attribute to track.

In an embodiment, dynamic adjustment and uncertain environments are key characteristics. The player may be in a state of uncertainty with many possible relevant dimensions present. The optimal spread of attention across the high dimensional space of options may change dynamically and rapidly throughout the game.

In an embodiment, many different dimensions are present and that the importance and relevance of each dimension changes rapidly throughout the game. The game may force the player to change focus on the dimensions of the game. The values within each dimension may change as well. The result is to put the player in a type of high dimensional “dance.” This in turn urges the player to switch attention between the changing information across all aspects of the game from one second to the next. Rapid adjustment of attention may be used in the service of gaining evidence for numerically relevant decisions.

In an embodiment of the present invention, the method further comprises the step of tracking 55 the player's progress throughout the interactive video game. For example, the player's progress may be tracked 55 using a graph. Progress may also be tracked 55 through a system of achievements. These achievements may be external to the interactive video game environment, but visible to others. In another example, achievements can be tracked 55 through the visual appearance of the avatar or the interactive video game environment.

In an embodiment of the present invention, the method further comprises the steps of measuring 75 one or more subsequent number sense acuity value(s) of the player, and preparing 85 a report using both the initial number sense acuity value and the subsequent number sense acuity value(s). The report may be accessible inside the interactive video game environment or available externally.

In an embodiment of the present invention, the method further comprises the step of measuring 15 an initial number sense acuity value of the player, wherein the initial number sense acuity value determines the point at which the player enters the game—the entry point. The interactive video game may have a plurality of entry points, each entry point having an associated degree of difficulty. The entry point may be a location within a game map, a level of game play, a difficulty level, or other way for differentiating game play. Similarly, the interactive video game may have a plurality of exit points. The interactive video game may allow for multiple paths (e.g., plot decisions) for a player to take within the game.

The game may allow variable entry points to ensure the initial difficulty level is appropriate. Then, as the game progresses, the difficulty of the game may increase to ensure a constant level of challenge. In one embodiment, this can include the manipulation of game aspects such as: (1) the pace of the game (speed of movement and action); (2) the number of elements the player need to track as they play; (3) the precision of the estimates needed to succeed (e.g., how accurately players have to aim at their target to make a hit). Generally, players are at the correct level of challenge if they can successfully complete about 85% of the game challenges—less may become discouraging for the player and more may become boring.

The initial number sense acuity value may be included when preparing 85 a report such that one can track number sense improvement in the player. In another embodiment of the present invention, a method further comprises the step of displaying 65 the number sense acuity value on a display. For example, the number sense acuity value can be displayed 65 within a heads-up display of the avatar. In another example, the number sense acuity value may be displayed 65 through changes or conditions in the video game environment. The number sense acuity value may also be displayed 65 in the interactive video game through a menu or other ways known in the art.

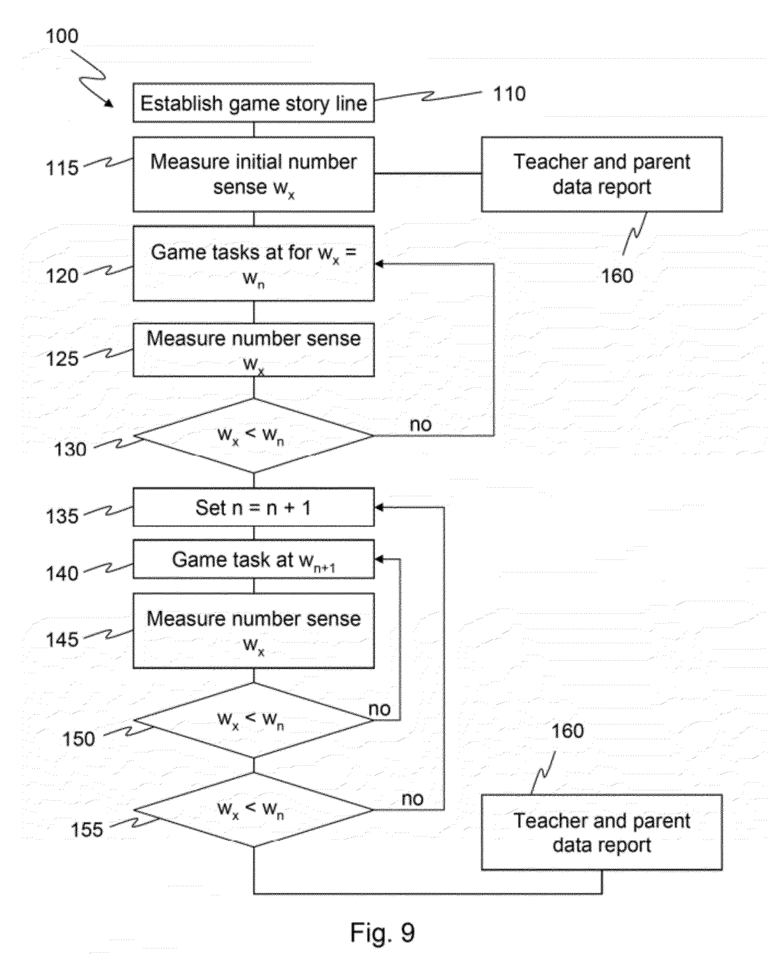

FIG. 9 illustrates another embodiment of a method 100 in keeping with the present invention. In this method 100, a story line is established 110. The story line may be engaging and interesting such that it compels the player to continue playing. An initial number sense acuity value (wₓ) is measured 115. Tasks are then provided 120 to teach number sense with the goal of improving the player's number sense acuity value to a target value (wₙ). The method 100 further comprises measuring 125 a subsequent number sense acuity value of the player and determining 130 whether or not the player's subsequent measured number sense acuity value has exceeded the target value (wₙ). If not, additional tasks are provided 120 until the player's measured number sense acuity value improves to exceed the acuity target value. Once the player's measured number sense acuity value exceeds the acuity target value, the difficulty (or level) may be increased 135, and a new number sense acuity target value may be set. Game tasks are provided 140 at a difficulty commensurate with the new acuity target value. The number sense acuity value is measured 145 during or after the completion of the more difficult tasks. The method 100 comprises determining 150 whether or not the player's measured number sense acuity value exceeds the number sense acuity target value. If so, the method 100 further comprises determining 155 if the player has reached a final number sense acuity value goal for the program. If not, the difficulty of the tasks is increased. At any point, a report may be compiled 160. The report may be configured to present information useful to an instructor and/or a parent. The report may comprise relevant data from the completed tasks and/or measured number sense acuity values.

Determination of the player's number sense acuity value may be performed early in the game. In one embodiment, the number sense acuity value is measured in a task which is integrated into the game plot. This measured number sense acuity value may not be visible to the player but may be accessible by an instructor or parent. In another embodiment, the initial number sense acuity value determines the starting values for the pace of the game, the number of elements in each task, and/or the accuracy level required for the task. After a period of play, another acuity level test is integrated into the action. The number sense acuity value is recorded in a teaching score card and used to adjust the pace, number, and/or accuracy factors for subsequent tasks. After subsequent periods of play the number sense acuity value (w) is re-tested and the game pace, number, and/or accuracy factors are adjusted to provide an increasing amount of challenge in the game. As the number sense acuity value (w) reaches certain levels, this achievement may be reflected in changes in the game environment. For example, the player may be on a higher level on the magical mountain, or further along a path to a more interesting village in the magical kingdom. When the measured number sense acuity value reaches the target level, the game may take the player to a winning level. For example, the winning level could be the top of a mountain, or the princess's tower window in the magical kingdom. The acuity levels collected during the course of the game may be made available in a separate report for the teacher or parent.

An embodiment of the present invention can be described as a method for training a player's number sense, the method comprising the steps of:
providing an interactive video game using a processor;
presenting a task to the player using a display, the task being generated using the processor;
receiving action information from a physical input device in electronic communication with the processor, the physical input device controlled by the player in response to the presented task;
measuring a number sense acuity value of the player based on the received action information, the measurement calculated by the processor; and
providing feedback to the player, the feedback being provided using the interactive video game based on the number sense acuity value.

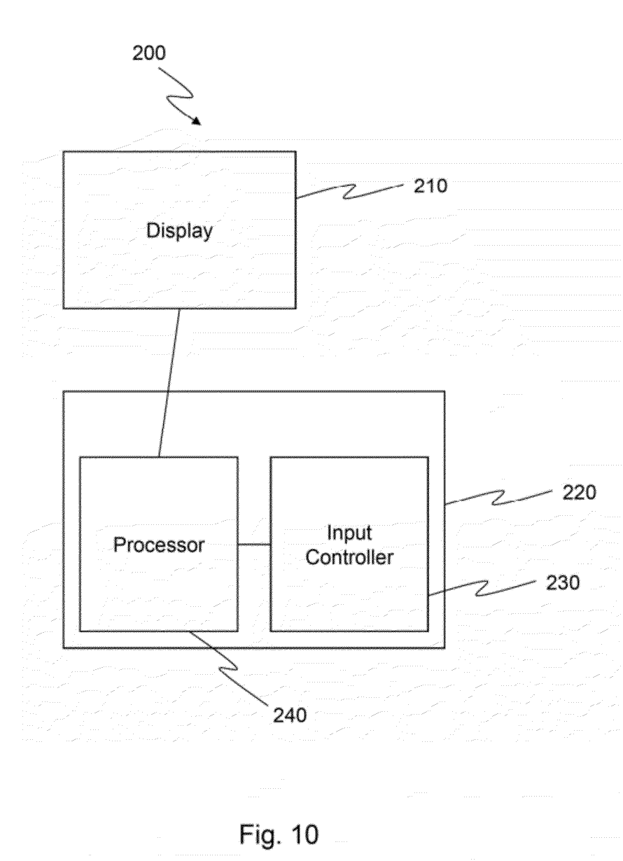

FIG. 10 illustrates a system 200 for training a number sense of a player according to an embodiment of the present invention. The system 200 comprises a display 210 and a video game system 220 in communication with the display 210. The video game system 220 comprises a processor 240 and an input controller 230 in electronic communication with the processor 240. The input controller 230 allows a player to interact with the video game system 220. The processor 240 may be programmed to perform any of the aforementioned methods. For example, the processor 240 may be programmed to present a task to the player using the display 210, receive action information from the input controller 230 (the input controller 230 receiving input from the player), measure a number sense acuity value of the player based on the action information received from the input controller 230, and provide feedback to the player (the feedback based on the measured number sense acuity value).

The video game may, for example, provide at least 50 hours of game play. The plot and action of the game may include sufficient complexity and variety to hold the interest of the player throughout the game. This may be achieved by keeping players at a high level of correct performance substantially throughout game play. A high level of performance, for example, may be approximately 85%.

The video game may be presented using a first player point of view, which ensures that the player has complete control over what they avatar sees. Control of the camera view may allow the player to orient their attention and executive resources during game play. The video game may urge participants to monitor their virtual surroundings at all times to act upon targets in their visual periphery. These targets may be dynamic in nature.

The video game may mesh goals and sub-goals at many different temporal scales. For example, goals may be meshed from the millisecond scale (immediate), to the tens-of-seconds, several minutes, more than 20 minutes, and/or other time scales.

The input controller 230 may be any type of device suitable for such purposes. The input controller 230 may be embodied to limit the time necessary for learning the specifics of the controller. For example, a motion sensing device (e.g., a WiiMote® or Microsoft Kinect® device) or a computer mouse may be used because an individual already know how to use their arms/hands to effect changes in the non-virtual world.

The video game's tasks, goals, environment, etc. may be sufficiently complex and rich to prevent the repetition of identical or nearly identical situations, which tends to foster specificity of learning like “mini-game” brain trainers. Events and outcomes may be probabilistic, but structured. Thus, players can learn to do better by learning these probabilities, but can never achieve perfect performance. The video game may be fun, arousing, and engaging. The best determinant of learning and expertise is the willingness of people to subject them to training The video game therefore may provide an engrossing experience whereby playing is chosen over other activities.

Learning may be efficient if players develop a sense of flow or the sense that one is able to meet the challenges of one's environment with appropriate skills. Flow may also be characterized by a deep sense of enjoyment which goes beyond satisfying a need, and rather occurs when a player achieves something unexpected which has a sense of novelty.

An interactive video game of the present invention may be embodied as an online video game. In this way, the video game may be used (played) by a player by way of the Internet, or a local area network. The interactive video game may be usable by more than one player simultaneously. Such multiuser game-play may be independent play (i.e., each player playing independent from the other player(s)) or may be interrelated play (i.e., each player may interact with other players—whether as teammates, as competitors, or otherwise).

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method for training a player's number sense, the method comprising the steps of:
providing an interactive video game;
presenting a task to the player, the task being presented using the interactive video game;
receiving action information from the player in response to the presented task;
measuring a number sense acuity value of the player based on the received action information; and
providing feedback to the player, the feedback being provided using the interactive video game based on the number sense acuity value.

2. The method of claim 1, wherein the step of presenting a task further comprises the sub-steps of:
displaying a plurality of stimuli on a display; and
inducing the player to estimate the number of displayed stimuli.

3. The method of claim 1, further comprising the step of displaying the number sense acuity value on a display.

4. The method of claim 1, wherein the interactive video game has a plurality of entry points, each entry point having an associated degree of difficulty.

5. The method of claim 4, further comprising the step of measuring an initial number sense acuity value of the player, wherein the initial number sense acuity value determines the entry point for the player.

6. The method of claim 2, wherein the player is induced to estimate the displayed stimuli over a period of time and/or within a space.

7. The method of claim 1, wherein the step of presenting a task further comprises the sub-steps of:
displaying a plurality of stimuli on a display; and
inducing the player to produce a target number of actions.

8. The method of claim 1, wherein the step of presenting a task further comprises the sub-steps of:
displaying a plurality of stimuli on a display, the plurality of stimuli arranged in at least two stimuli subsets; and
inducing the player to compare the number of stimuli in the at least two stimuli subsets.

9. The method of claim 1, wherein the step of presenting a task further comprises the sub-steps of:
displaying a symbolic arithmetic event and a non-symbolic arithmetic event on a display; and
inducing the player to estimate a result of the symbolic arithmetic event and the non-symbolic arithmetic event.

10. The method of claim 1, wherein the step of presenting a task further comprises the sub-steps of:
displaying a plurality of stimuli on a display, each stimuli having a numerosity; and
inducing the player to organize each stimulus according to numerosity.

11. The method of claim 1, the step of presenting a task further comprising the sub-step of:
displaying a plurality of stimuli on a display, each stimuli having more than one dimension; and
inducing the player to organize each stimulus according to the dimensions of the stimulus.

12. The method of claim 1, wherein the task is presented through more than one modality.

13. The method of claim 12, wherein the modalities comprise two or more modalities selected from vision, audition, or touch.

14. The method of claim 12, wherein the modalities through which tasks are presented vary throughout the interactive video game.

15. The method of claim 1, wherein the step of presenting a task further comprises the sub-steps of:
displaying a plurality of stimuli on a display, the stimuli at least partially obscured; and
inducing the player to gather evidence of the stimuli through altering the player's view in the interactive video game.

16. The method of claim 1, further comprising the step of tracking the player's progress throughout the interactive video game.

17. The method of claim 16, wherein the player's progress is tracked using a graph.

18. The method of claim 1, wherein more than one task is simultaneously presented to the player, wherein each task has a different temporal scale.

19. The method of claim 1, further comprising the steps of:
measuring a subsequent number sense acuity value of the player; and
preparing a report using the number sense acuity value and the subsequent number sense acuity value.

20. A system for training number sense of a player, the system comprising:
a display; and
a video game system in communication with the display, the video game system comprising:
a processor; and
an input controller in electronic communication with the processor, the input controller allowing the player to interact with the video game system;
the processor programmed to:
present a task to the player using the display;
receive action information from the input controller, the input controller being manipulated by the player in response to the presented task;
measure a number sense acuity value of the player based on the action information received from the input controller; and
provide feedback to the player, the feedback based on the measured number sense acuity value.
